(19) United States
(12) Patent Application Publication
(10) Pub. No.: US 2017/0148488 A1
(43) Pub. Date: May 25, 2017

(54) VIDEO DATA PROCESSING SYSTEM AND ASSOCIATED METHOD FOR ANALYZING AND SUMMARIZING RECORDED VIDEO DATA

(71) Applicant: MediaTek Inc., Hsin-Chu (TW)

(72) Inventors: Chia-Ying LI, Taipei City (TW); Shen-Kai CHANG, Zhubei City (TW); Yu-Hao HUANG, Kaohsiung City (TW); Tsu-Ming LIU, Hsinchu City (TW)

(21) Appl. No.: 15/259,136

(22) Filed: Sep. 8, 2016

Related U.S. Application Data
(60) Provisional application No. 62/257,755, filed on Nov. 20, 2015.

(51) Int. Cl. G11B 27/034; G11B 27/11; G06K 9/00; H04N 5/91

(52) U.S. Cl. CPC G11B 27/034; H04N 5/91; G11B 27/11; G06K 9/00765

(57) ABSTRACT

A video data processing system and an associated method for generating a summarized video of a recorded video are provided. The method includes the steps of: receiving video data and recording-related information generated during recording video data from at least one source; analyzing the recording-related information and extracting required information from the recording-related information to generate metadata information for the received video data; cropping the received video data to generate cropped video data based on the metadata information; and generating a summarized video of the recorded video data based on the cropped video data.

### CROSS REFERENCE TO RELATED APPLICATIONS

This application claims the benefit of U.S. Provisional Application No. 62/257,755, filed on Nov. 20, 2015, the entirety of which is incorporated by reference herein.

### BACKGROUND OF THE INVENTION

Field of the Disclosure

The disclosure relates to video recording and processing, and, in particular, to a video data processing system and method for generating a summarized video of a recorded video using the same.

Description of the Related Art

With the development of computer technology, applications of video recording have become more and more popular. Electronic devices on the market, such as video camera, mobile device, UAV (Unmanned Aerial Vehicle), or any other electronic device, are usually equipped with video recording function, and more and more people are using the video recording function for video recording on such electronic devices. However, when a large size of video is recorded, a huge amount of storage space is required and long uploading time to network and bad readability may be encountered.

Moreover, users may wish to share and view video content easily and quickly or it may be desirable to reduce a video to a specific size for compressing or sending over a network after recording. However, if the videos are too large, users must edit the content in a separate program to make the video short enough for easy and quick viewing. These features are not commonly available on the devices, so users must use applications (APPs) to manually edit the recorded video or download the content to a computer to perform the editing so as to shorten a video. However, this is often beyond either the skill level of the user, or requires too much time and effort to be practical.

Accordingly, there is demand for an intelligent video data processing system and an associated method for generating a summarized video of a recorded video to solve the aforementioned problem.

### BRIEF SUMMARY OF THE DISCLOSURE

A detailed description is given in the following implementations with reference to the accompanying drawings.

In an exemplary implementation, a method for generating a summarized video of a recorded video in a video data processing system is provided. The method includes the steps of: receiving video data and recording-related information generated during recording video data from at least one source; analyzing the recording-related information and extracting required information from the recording-related information to generate metadata information for the received video data; cropping the received video data to generate cropped video data based on the metadata information; and generating a summarized video of the recorded video data based on the cropped video data.

In another exemplary implementation, a video data processing system is provided. The video data processing system includes an importance analyzer and a video encoder. The importance analyzer is configured to receive recording-related information generated during recording video data from at least one source and extract required information from the recording-related information to generate metadata information for the recorded video data. The video encoder is coupled to the importance analyzer and is configured to receive the recorded video data and the metadata information and crop the received video data to generate cropped video data based on the metadata information and generate the summarized video of the recorded video data based on the cropped video data.

In yet another exemplary implementation, a video data processing system is provided. The video data processing system includes an importance analyzer, a video encoder and a summarization engine. The importance analyzer is configured to receive recording-related information generated during recording video data from at least one source and extract required information from the recording-related information to generate metadata information for the recorded video data. The video encoder is coupled to the importance analyzer and is configured to receive the recorded video data and the metadata information and encode the recorded video data to generate an encoded video bitstream with the metadata information. The summarization engine is configured to receive the encoded video bitstream with the metadata information and crop the encoded video bitstream to generate cropped video data based on the metadata information and generate the summarized video of the recorded video data based on the cropped video data.

In yet another exemplary implementation, a video data processing system is provided. The video data processing system includes an importance analyzer, a video encoder and a summarization engine. The importance analyzer is configured to receive recording-related information generated during recording video data from at least one source, extract required information from the recording-related information to generate metadata information for the recorded video data and store the metadata information into a storage device. The video encoder is configured to receive the recorded video data and encode the recorded video data to generate an encoded video bitstream. The summarization engine is configured to receive the encoded video bitstream and obtain the metadata information from the storage, crop the encoded video bitstream to generate cropped video data based on the metadata information and generate the summarized video of the recorded video data based on the cropped video data.

### BRIEF DESCRIPTION OF THE DRAWINGS

The disclosure can be more fully understood by reading the subsequent detailed description and examples with references made to the accompanying drawings, wherein:

FIG. 1A is a diagram of a video data processing system in accordance with an implementation of the disclosure;

FIG. 1B is a diagram of a video data processing system configuration in accordance with an implementation of the disclosure;

FIG. 1C is a diagram of a video data processing system configuration in accordance with another implementation of the disclosure;

FIG. 2 is a flow chart of a method for generating a summarized video of a recorded video in accordance with an implementation of the disclosure;

FIGS. 3A to 3D are diagrams illustrating summarized videos of recorded video data in accordance with implementations of the disclosure;

FIGS. 4A to 4D are diagrams illustrating ROI detections in accordance with implementations of the disclosure;

FIG. 5 is a diagram of a video data processing system in accordance with another implementation of the disclosure;

FIG. 6 is a diagram of a video data processing system in accordance with another implementation of the disclosure; and

FIG. 7 is a diagram of a video data processing system in accordance with another implementation of the disclosure.

### DETAILED DESCRIPTION OF THE DISCLOSURE

The following description is made for the purpose of illustrating the general principles of the disclosure and should not be taken in a limiting sense. The scope of the disclosure is best determined by reference to the appended claims.

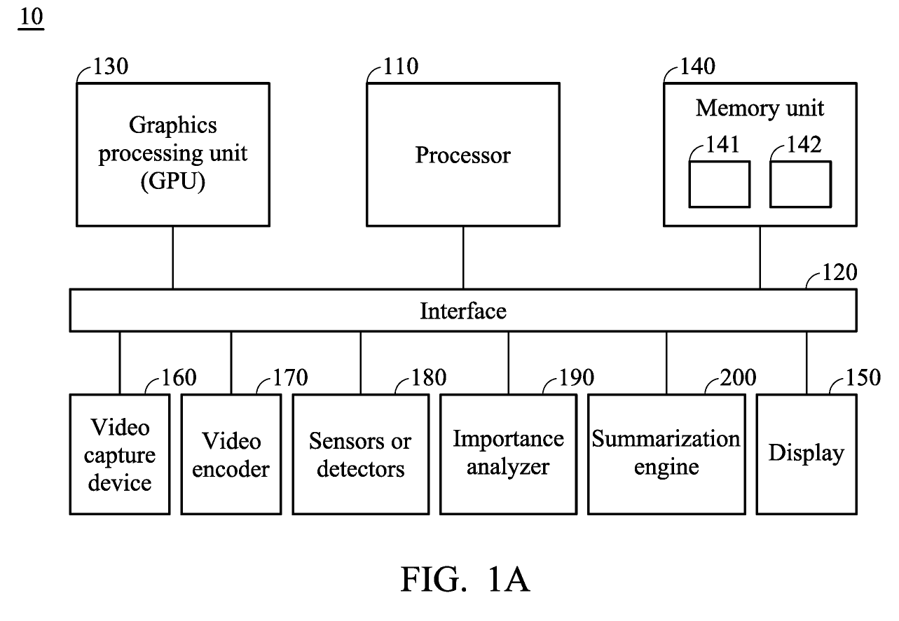

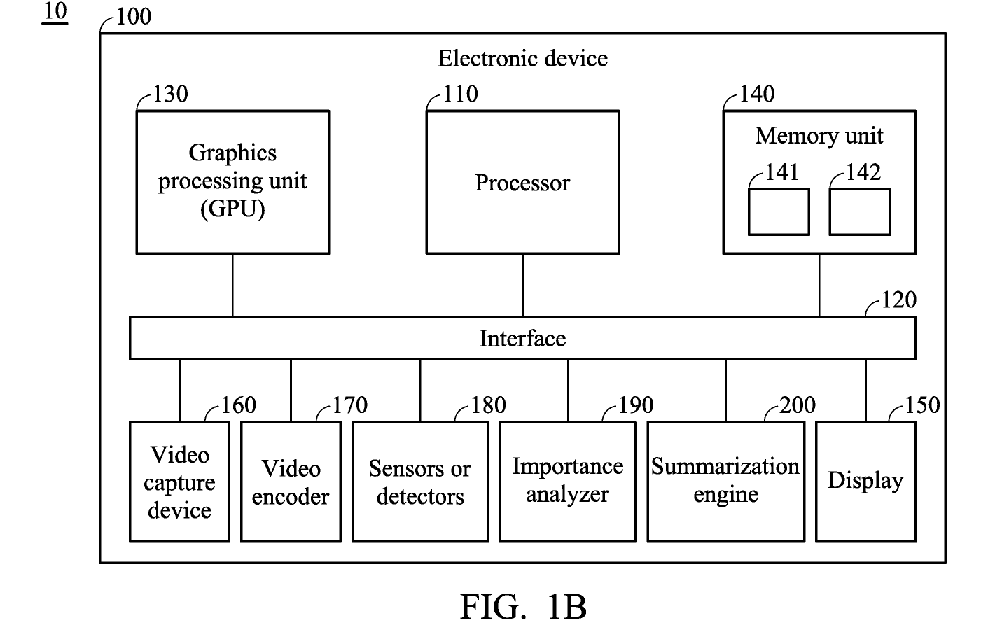

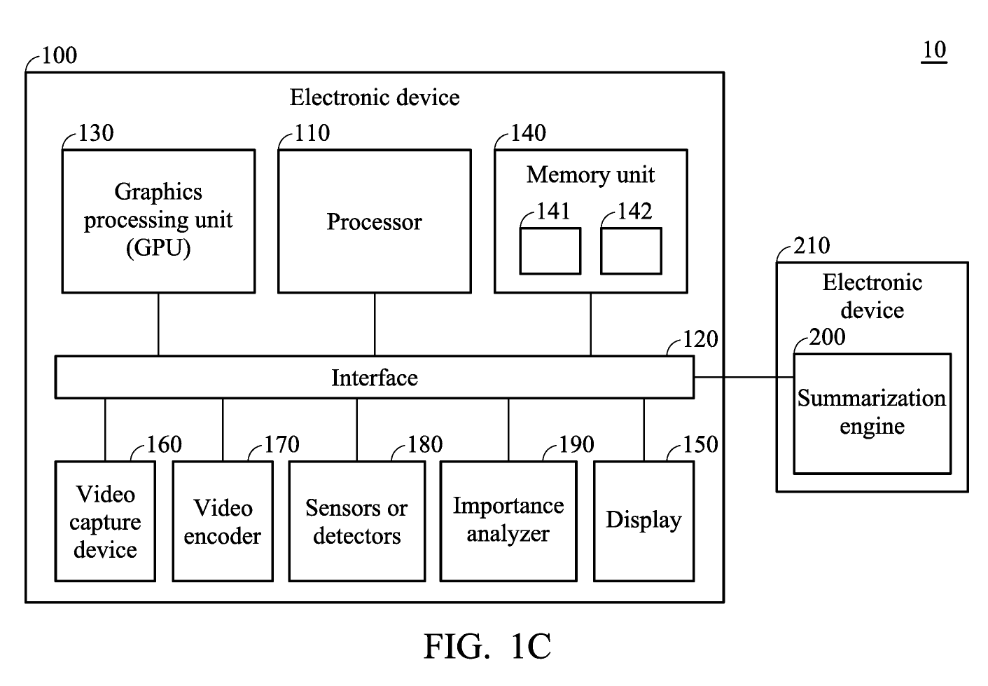

FIG. 1A is a diagram of a video data processing system in accordance with an implementation of the disclosure. The video data processing system 10 can be implemented in an electrical device, such as a mobile device (e.g., a tablet computer, a smartphone, or a wearable computing device) or a laptop computer capable of acquiring images or video data. The video data processing system 10 can also be implemented as multiple chips or a single chip such as a system on chip (SOC) or a mobile processor disposed in a mobile device. For example, the video data processing system 10 comprises at least some of a processor 110, an interface 120, a graphics processing unit (GPU) 130, a memory unit 140, a display 150, a video capture device 160, a video encoder 170 and a plurality of sensors or detectors 180 and an importance analyzer 190.

The processor 110, the GPU 130, the memory unit 140, the video encoder 170, the sensors or detectors 180 and the importance analyzer 190 can be coupled to each other through the interface 120. The interface 120 may be any wired or wireless data transmission interface or any combination thereof. The processor 110 may be a central processing unit (CPU), a general-purpose processor, a digital signal processor (DSP), or any equivalent circuitry, but the disclosure is not limited thereto. The memory unit 140, for example, may include a volatile memory 141 and/or a non-volatile memory 142. The volatile memory 141 may be a dynamic random access memory (DRAM) or a static random access memory (SRAM), and the non-volatile memory 142 may be a flash memory, a hard disk, a solid-state disk (SSD), etc. For example, the program codes of the applications for use on the video data processing system 10 can be pre-stored in the non-volatile memory 142. The processor 110 may load program codes of applications from the non-volatile memory 142 to the volatile memory 141, and execute the program code of the applications. The processor 110 may also transmit the graphics data to the GPU 130, and the GPU 130 may determine the graphics data to be rendered on the display 150. It is noted that although the volatile memory 141 and the non-volatile memory 142 are illustrated as a memory unit, they can be implemented separately as different memory units. In addition, different numbers of volatile memory 141 and/or non-volatile memory 142 can be also implemented in different implementations. The display 150 can be a display circuit or hardware that can be coupled for controlling a display device (not shown). The display device may include either or both of a driving circuit and a display panel and can be disposed internal or external to the video data processing system 10.

The video capture device 160 may perform a video recording function to capture video data. The video capture device 160 may comprise imaging sensors which may be a single sensor or a sensor array including a plurality of individual or separate sensor units, such as a video camera, a UAV (Unmanned Aerial Vehicle), or any other electronic device capable of perform the video recording. The video capture device 160 can obtain video data with a plurality of video frames and provide the video frames to the video encoder 170 when performing video recording.

The video encoder 170 is coupled to the video capture device 160 to obtain the video frames and encode the video frames to generate encoded video data, such as encoded video bitstream, in any suitable media format compatible with video standards, such as the H.264, Mpeg4, HEVC or any other video standard. The video encoder 170 may be, for example, a standard video encoder, a video encoder with pre-warping function or a video encoder with cropping information embedding function, but the disclosure is not limited thereto. When the video encoder 170 is the video encoder with pre-warping function, it may further perform a remapping or warping operation on the encoded video bitstream during encoding to remove distortion on the original video data. When the video encoder 170 is the video encoder with cropping information embedding function, it may further embed cropping information into the encoded video bitstream such that a decoder (not shown), upon receiving the encoded video bitstream with the cropping information, may do respective warping operation to recover the undistorted view of the video data.

The sensors or detectors 180 may provide sensor data for various status data corresponding to the video data processing system 10 and/or the video content during recording a video data. For example, the sensors or detectors 180 can be one or more of following: audio-based signal detectors, camera sensors, motion detectors, location detectors, object detectors, timers, devices from a connected network or region-of-interest (ROI) detectors, but the disclosure is not limited thereto.

The importance analyzer 190 may obtain required information from a plurality of sources to generate reference information (hereinafter also referred to as metadata information). To be more specific, information of a plurality of sources (e.g., the sensors or detectors 180) are collected during performing the video recording as recording-related information and the importance analyzer 190 may then receive these recording-related information from the sources and extract required information from the recording-related information to generate metadata information for the recorded video data. Metadata information may contain information corresponding to the device status information and/or video content during the video recording for selecting cropped video frames. The recording-related information may provide status of one or more device signals and other signals related to the video recording and collect respective information therefrom. The recording-related information may comprise information regarding one or more of the following: audio-based signal detection, camera sensor information, motion detector information, location detector information, object detector information, timer information, other device information from a connected network or user defined ROI information.

The importance analyzer 190 can further be configured to perform a video analysis on the original video raw data, such as sensing an appearance and disappearance of an object or sensing a motion of an object, background region detection, foreground and object detection and ROI detection (e.g., face detection) in the original video. The importance analyzer 190 may then obtain required information about the video from the recording-related information. In some implementations, the metadata information can be included in a H.264 sei message to be inserted between the video frames or an mp4 user data (udata) message when a specific event occurred, for example, and the H.264 sei message or the mp4 user data (udata) message may be embedded in a corresponding bitstream.

To be more specific, the sensor data associated with the sensors or detectors 180 may be logged/collected while video recording. This may include information regarding the movement of the device from the device's accelerometer and/or the rotation of the device based on the device's gyroscope. This logged data (also referred to as metadata information) may be analyzed to find cropping portions in the video raw data. In one implementation, during video recording, the video data processing system 10 can request a measurement from a motion detector and accesses sensor data measured by the motion detector. For example, but not limited to, the motion detector can be a gyroscope, accelerometer, gravity sensor, light sensor or the like, which is used to determine motion of the video data processing system 10. In another implementation, the video data processing system 10 may also request a measurement from a location detector. For example, but not limited to, the location detector can be a GPS sensor, barometer, magnetic fields sensor, compass, gravity sensor, air pressure or the like, which is used to provide a location information of the video data processing system 10. In another implementation, the source can also be audio-based source, which is used to perform audio-based detection on the video be recorded, such as a detection of specific sounds, e.g., voice, applause, hooray, loudness, pattern recognition or the like. In another implementation, the source can also be an object detector, which is used to perform object detection operations on the video be recorded, such as face detection, face recognition, object detection, object recognition or the like. In another implementation, the source can also be a camera sensor, which is used to perform camera-related operation and detection on the video be recorded and generate respective information, such as auto focus detection information, light level detection information, noise level detection information or the like. In another implementation, the source can also be other devices connected by a connected network (e.g., Internet or wireless network), such as medical device providing heart beat rate and body temperature information, hygrometer, PM 2.5 monitoring instruments or the like.

In this implementation, the video data processing system 10 may further comprise a summarization engine 200. The summarization engine 200 can be configured to crop the received video data to generate cropped video data based on the metadata information generated by the importance analyzer 190 and to generate the summarized video of the recorded video data based on the cropped video data such that most of the interesting parts of the video are well-represented.

In one implementation, the video encoder 170 and the summarization engine 200 are resident on a same electronic device. In some other implementations, the processor 110, the interface 120, the GPU 130, the memory unit 140, the display 150, the video capture device 160, the video encoder 170 and the plurality of sensors or detectors 180 and the importance analyzer 190 may be implemented in more than one device, which should not be limited in this disclosure.

FIG. 1B is a diagram of a video data processing system configuration in accordance with an implementation of the disclosure while FIG. 1C is a diagram of another video data processing system configuration in accordance with another implementation of the disclosure. In the configuration of the video data processing system 10 as shown in FIG. 1B, the video encoder 170 and the summarization engine 200 are resident on a same electronic device 100. The electronic device 100 can be, for example, a mobile device (e.g., a tablet computer, a smartphone, or a wearable computing device) or a laptop computer capable of acquiring images or video data, and the disclosure is not limited thereto.

In another configuration of the video data processing system 10 as shown in FIG. 1C, the video encoder 170 and the summarization engine 200 are separately resident on two electronic devices, such as the video encoder 170 can be disposed on the electronic device 100 while the summarization engine 200 can be disposed on another electronic device 210, as shown in FIG. 1C.

The video encoder 170 may operate by hardware circuits disposed on the electronic device 100, or by software modules executed by a processor of the electronic device 100. The summarization engine 200 may operate by hardware circuits of the electronic device 210, or by software modules executed by a processor of the electronic device 210. In other implementations, the summarization engine 200 can also be omitted (not shown).

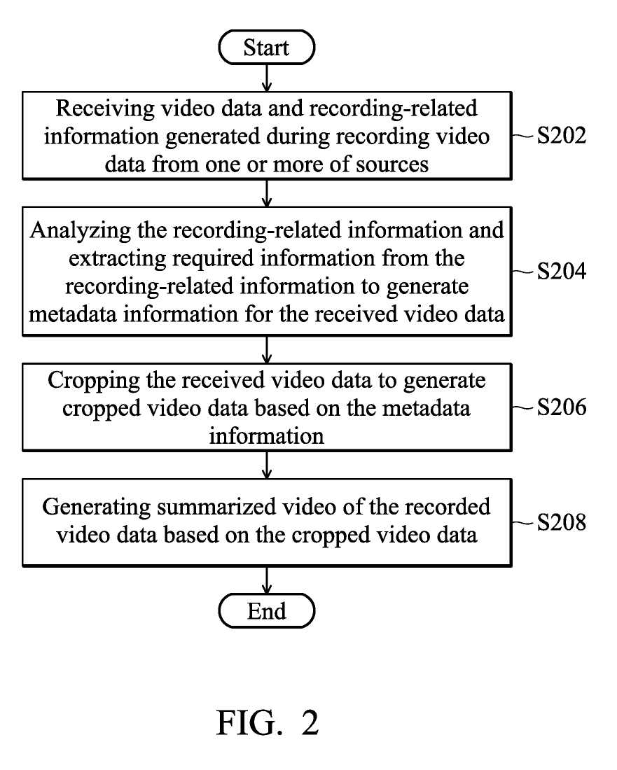

FIG. 2 is a flow chart of a method for generating a summarized video of a recorded video in another implementation of the disclosure. The method may be performed by the video data processing system 10 in FIG. 1A or FIG. 1B, for example. The video data processing system 10 of FIG. 1A or 1B is utilized here for explanation of the flow chart, which however, is not limited to be applied to the video data processing system 10 only.

In step S202, video data and recording-related information generated during recording video data from one or more of sources (e.g., the sensors or detectors 180) are received. The step S202 may be performed by the video encoder 170 and/or the importance analyzer 190 in FIG. 1A, for example. Particularly, the video recording may be initiated according to a hardware or software button, or in response to another control signal generated in response to a user action. For example, a button that is pushed may select a video sensor and a video has been selected and video recording will be initiated. In this implementation, the sources can be one or more of following: audio-based signal detectors, camera sensors, motion detectors, location detectors, object detectors, timers, devices from a connected network or ROI detectors, but the disclosure is not limited thereto. The recording-related information that are generated by the one or more sources may provide status of one or more device signals and other signals collected during the video recording and collect respective information therefrom. The recording-related information may comprise information regarding one or more of the following: audio-based signal detection, camera sensor information, motion detector information, location detector information, object detector information, timer information, other device information from a connected network or user defined ROI information as aforementioned.

For example, when the sensors or detectors 180 of the video data processing system 10 comprise a motion detector, such as a gyroscope, accelerometer, gravity sensor, light sensor or the like, the video data processing system 10 can request a measurement from the motion detector and the motion detector may generate sensor data accordingly while the video is being recorded. The sensor data (i.e., the motion detector information) measured by the motion detector may then be accessed by the importance analyzer 190 to determine motion of the video data processing system 10.

In step S204, the recording-related information is analyzed and required information is extracted from the recording-related information to generate metadata information for the received video data. The step S204 may be performed by the importance analyzer 190 in FIG. 1A, for example. To be more specific, the importance analyzer 190 may obtain required data from the one or more sources to analyze video/audio signals in the image and video data to determine the importance portions or removing portions of the received video data based on the recording-related information and use the recording-related information corresponding to the importance portions or removing portions as the required information to generate the metadata information for the received video data. In some implementations, a specific group of recording-related information can be predefined, such as the ROI detection information, as the required information for generating the metadata information so that a specific set of video frames, e.g., all of the video frames with detected ROIs in the received video data can be preserved. In another or the same implementation, the ROI detection information can be obtained by performing an ROI detection on video frames of the received video data based on a predetermined ROI data to detect at least one ROI position on the received video data. To be more specific, a video analysis can be performed on the original video raw data, such as sensing an appearance and disappearance of an object or sensing a motion of an object, background region detection, foreground and object detection and ROI detection (e.g., face detection) in the original video and the respective analyzing result can later be applied to determine the cropped video data.

In step S206, the received video data is cropped to generate cropped video data based on the metadata information. The step S206 may be performed by the video encoder 170 or the summarization engine 200 in FIG. 1A, FIG. 1B or FIG. 1C, for example.

Specifically, the importance portions or removing portions of the received video data can be determined based on the metadata information associated with the received video data, and the cropped video data can be generated according to the importance portions or removing portions of the received video data. The cropped video data may include the importance portions of the received video data but exclude the removing portions of the received video data. In one implementation, in a case where the metadata information includes ROI detection information, all of the video frames with the ROI detected in the received video data are marked as the importance portions and the cropped video data are determined according to the marked video frames. For example, all of the video frames with detected ROIs in the received video data can be set as cropped video data when the metadata information includes the ROI detection information.

After the cropped video data are generated, in step S208, a summarized video of the recorded video data is generated based on the cropped video data. The step S208 may be performed by the video encoder 170 or the summarization engine 200 in FIG. 1A, FIG. 1B or FIG. 1C, for example. To be more specific, all of the cropped video data can be collected and remaining portions (also referred to as the removing portions) of the original video data can be removed from the original video data to generate the summarized video. Cropped video segments may be saved and shared using their cropped lengths, and combined with other segments as desired. For example, in an implementation where the respective metadata of a specific region includes detected ROI information, when the detected ROI information indicates a user-specified ROI, the importance analyzer 190 marks each video frame with the user-specified ROI as a cropped portion and preserves all of the cropped portions. The ROI is preserved within the cropped video data. The ROI may be identified based on motion detection or face detection, for example.

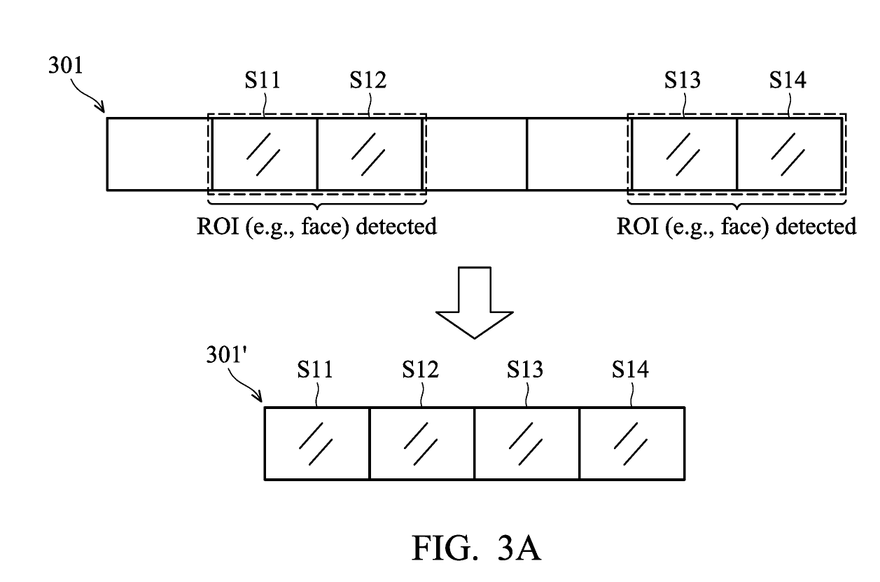

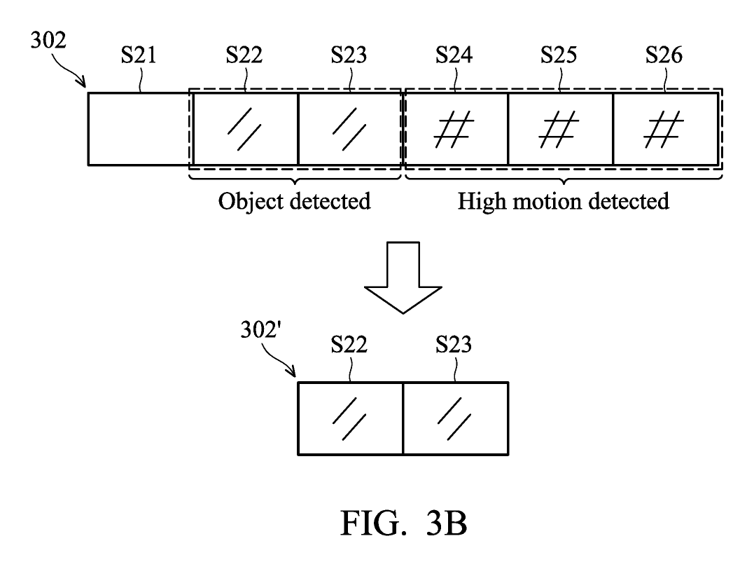

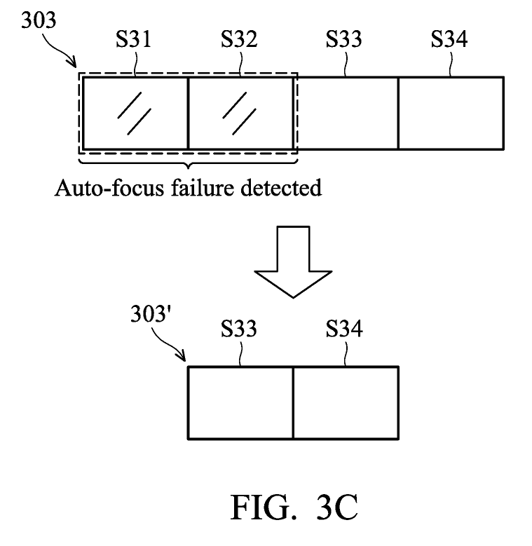

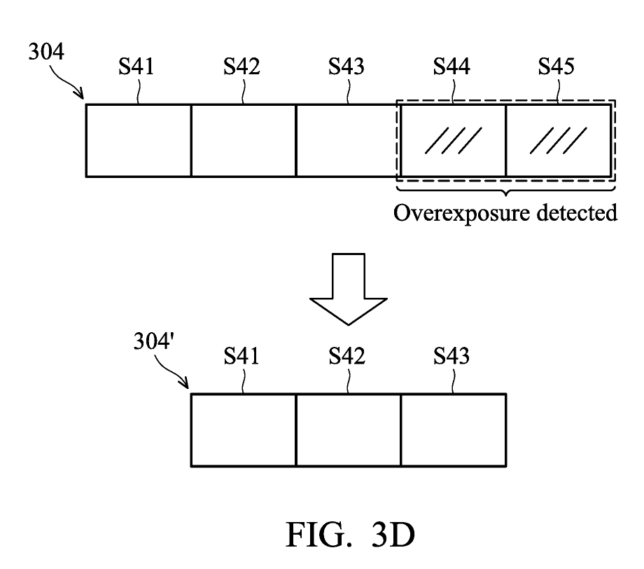

FIG. 3A is a diagram of a summarized video of a recorded video in accordance with an implementation of the disclosure. In this implementation, those video segments or frames with object detected may be preserved for generating the summarized video. As shown in FIG. 3A, there are a number of video segments including segment S11, segment S12, segment S13 and segment S14 in the video data 301, and only the segments S11, S12, S13 and S14 have the ROI (e.g., a predetermined object or face) detected. Accordingly, the segments S11, S12, S13 and S14 are marked and preserved and are later be utilized as the cropped video data to generate a summarized video 301′ of the video data 301 based on the ROI detection result. For the purposes of description, the number of cropped video segments is 4 in the aforementioned implementation. One having ordinary skill in the art will appreciate that a different number of cropped video segments can be used to generate a summarized video.

In another implementation, during video summarization, video frames with object detected can be preserved while those with abnormal high motion detected by a motion detector (e.g., an accelerometer or G-sensor) can be discarded. For example, those frames with object (e.g., a lead or importance person in a play) detected can be preserved and those frames with abnormal high motion detected can be discarded and removed from the summarized video. FIG. 3B is a diagram of a summarized video of a recorded video in accordance with another implementation of the disclosure. As shown in FIG. 3B, a video data 302 includes six segments S21, S22, S23, S24, S25 and S26, in which the segments S22 and S23 have the object detected and are preserved while the segments S24, S25 and S26 have high abnormal movement detected (which may be determined by using the motion sensor information detected by the accelerometer). Thus, the segments S24, S25 and S26 are discarded and only the segments S22 and S23 are later be utilized as the cropped video data used to generate the summarized video 302′ according to the object detection and motion detection results.

In another implementation, during video summarization, the metadata information may further comprise focusing information for each video frame which indicates whether the auto focus is failed and the focusing information can be obtained to determine which frame may be discarded and removed from the summarized video. Those frames with focusing information indicating that the auto focus is failed are determined to be frames to be removed and thus are removed from the original video to generate the summarized video. FIG. 3C is a diagram of a summarized video of a recorded video in accordance with another implementation of the disclosure. As shown in FIG. 3C, a video data 303 includes four segments S31, S32, S33 and S34, in which focusing information of the segments S31 and S32 both indicate that the auto focus for which are failed, and thus the segments S31 and S32 are discarded and only the segments S33 and S34 are used to generate the summarized video 303′ according to the auto focus detection result.

In some implementations, the metadata information may further comprise exposure information for each video frame, which indicates whether it is overexposure, and the exposure information can be obtained to determine which frame can be discarded and removed from the summarized video. Those frames with exposure information indicating that it is overexposure are determined to be frames to be removed and thus are removed from the original video to generate the summarized video. FIG. 3D is a diagram of a summarized video of a recorded video in accordance with another implementation of the disclosure. As shown in FIG. 3D, a video data 304 includes five segments S41, S42, S43, S44 and S45, in which exposure information of the segments S44 and S45 both indicate that they are overexposure, and thus the segments S44 and S45 are discarded and the segments S41, S42 and S43 are used as the cropped video data to generate the summarized video 304′ according to the exposure detection result.

It should be understood that, in the above implementations, the data size of the cropped video data is smaller than that of the received video data.

In some implementations, methods for summarization of a large-resolution or high-resolution video may further be provided as an example. The method can be applied to reduce a size of a large-resolution or high-resolution video to as same as or similar to that of normal video. In the following implementations, the large-resolution or high-resolution video can be a video with a large resolution (e.g., 8K*4K), such as a 360-degree video, a panorama video or the like. It should be understood that, in the following implementations, an image quality of the cropped video data is the same as that of the received video data.

The input of the large-resolution or high-resolution video can be generated by a single captured video, multiple captured videos or a stitching result of the multiple captured videos. A ROI detection is first performed on the large-resolution or high-resolution video. To be more specific, each of video frames of the large-resolution or high-resolution video are performed with a ROI detection based on a predetermined ROI data to detect at least one ROI position on the large-resolution or high-resolution video. The ROI may be identified based on motion detection or face detection, for example. The predetermined ROI data may be a default feature (e.g., by a specific object or face) or a specified-region defined by the user (e.g., by a touch on a touch screen panel) during video recording. After the ROI detection is completed, as the ROI is auto detected, more than one ROI may be found or a size of the detected ROI may not match a desired resolution. Therefore, several strategies are provided to solve the aforementioned problems. It should be noted that, in some embodiments, there may be no ROI position detected on a specific video segment after the ROI detection is completed. In such case, this specific video segment can be directly discarded or the position of a previously cropped ROI (previous cropping region) can be utilized as the ROI position of the specific video segment.

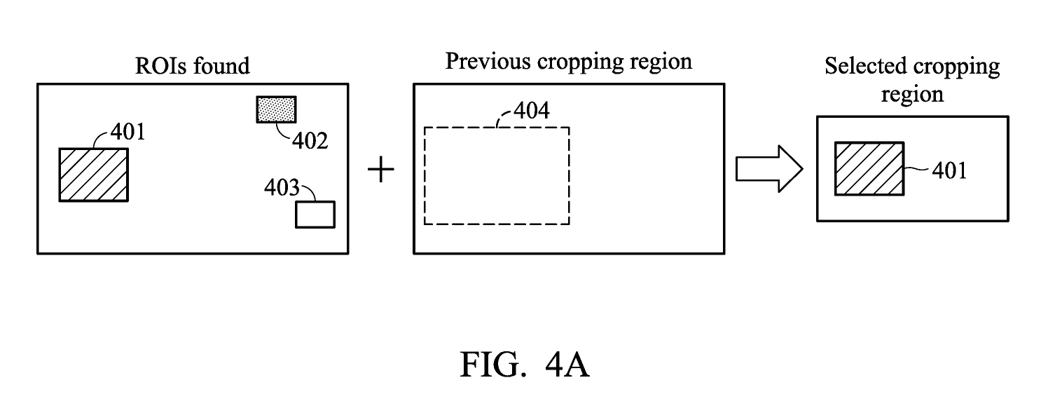

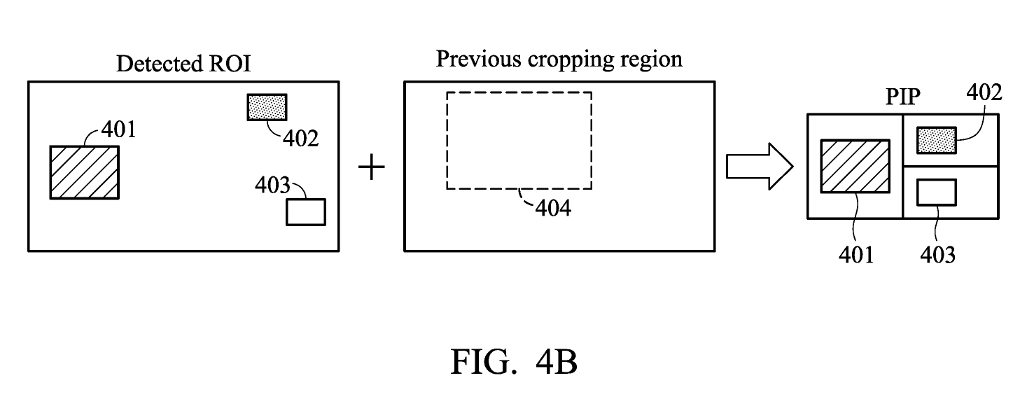

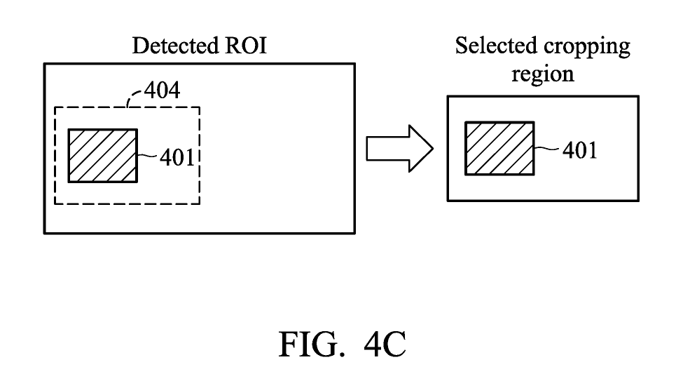

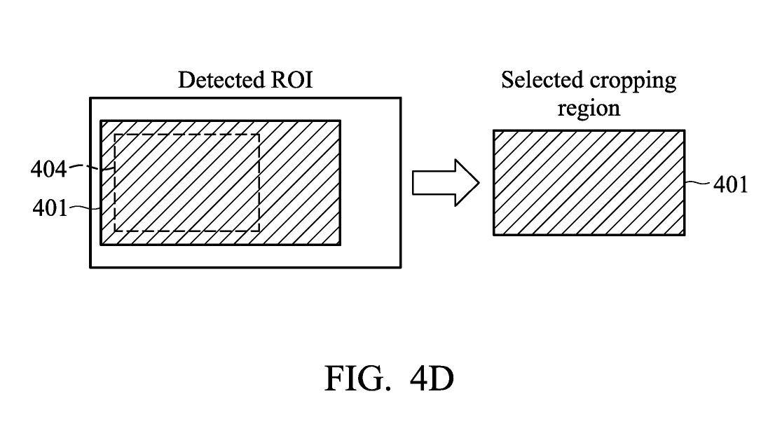

In one implementation, when multiple ROIs on a first video frame of received video data have been found after the ROI detection is performed, one of the ROIs can be selected to be the detected ROI of the first video frame based on a position of a previously cropped ROI to preserve video fluency. FIG. 4A is a diagram of a ROI detection in accordance with an implementation of the disclosure. As shown in FIG. 4A, there are three ROIs 401, 402 and 403 be found. According to the position of a previously cropped ROI (previous cropping region) 404, the ROI 401 can be selected to be the detected ROI since the position of the ROI 401 is closer to the position of the previously cropped ROI 404 then other found ROIs 402 and 403. Thus, a selected cropping region associated with the ROI 401 can be determined.

In another implementation, when multiple ROIs on a specific video frame of the received video data have been found, the found ROIs can further be divided into a picture-in-picture (PIP) form on the specific video frame to preserve more ROIs. FIG. 4B is a diagram of a ROI detection in accordance with another implementation of the disclosure. As shown in FIG. 4B, there are three ROIs 401, 402 and 403 be found. In this implementation, according to the previously cropped ROI (previous cropping region) 404, a PIP is generated, wherein the PIP includes all of the found ROIs 401, 402 and 403. In the PIP as shown in FIG. 4B, the ROI 401 is set as a master picture and the ROIs 402 and 403 are set as sub-pictures, for example. With the PIP, more ROIs can be preserved.

In another implementation, it is further determined whether a size of the detected ROI matches a desired resolution, wherein a cropping region of the detected ROI is to be resized based on a size of a previously cropped ROI when the size of the detected ROI does not match the desired resolution. To be more specific, the cropping region of the detected ROI may be expanded or cropped based on a comparison result of the size of the detected ROI and the desired resolution. If the size of the detected ROI is smaller than the desired resolution, the cropping region of the detected ROI can be expanded to the desired resolution based on the size of the previously cropped region, as shown in FIG. 4C. For example, in FIG. 4C, the size of the detected ROI 401 is 640*480, which is smaller than a desired resolution (e.g., a resolution of 1024*768), and thus the cropping region of the detected ROI 401 can be expanded to the desired resolution based on the size of the previously cropped region 404.

If the size of the detected ROI is larger than the desired resolution, the size of the cropping region of the detected ROI can be cropped to the desired resolution based on the size of the previously cropped region, as shown in FIG. 4D. For example, in FIG. 4D, the size of the detected ROI 401 is 1024*768, which is larger than the desired resolution (e.g., a resolution of 640*480), and thus the size of the cropping region of the detected ROI 401 can be cropped to the desired resolution based on the size of the previously cropped region 404. In some other embodiments, the detected ROI 401 may be further processed to the desired resolution (e.g., a resolution of 640*480), which should not be limited in this disclosure.

Compared to original video data processing system without providing video cropping, by the video data processing system providing video cropping of the disclosure, memory bandwidth, network bandwidth, and encoding complexity can be saved due to the reduced size of frame buffer. For example, when a video with a size of 8 k*4 k can be cropped to a video with a size of 2 k*1 k, the size of the frame buffer required is reduced from 8092*4096*1.5 to 2048*1080*1.5.

Furthermore, as a 360-degree stitched image may be distorted in some region for rectangular image representation, warping operation may be needed to recover the distorted region so as to obtain better viewing experience. To be more specific, the cropped video data can be remapped or warped to remove distortion on the cropped video data, and the remapped or warped video data are then encoded to generate the summarized video of the recorded video. For example, in one implementation, the video encoder 170 can be a video encoder with cropping information embedding function, wherein it may further embed cropping information into the encoded video bitstream such that a decoder (not shown), upon receiving the encoded video bitstream with the cropping information, may do respective warping operation to recover the undistorted view of the video data.

In some implementations, summarization of the video can be performed on the fly on the encoder side or be performed off line on the transcoder side, thereby providing more flexibility in video summarization. The term “on the fly” means that summarization of the video is performed in real time during the video recording. The other term “off line” means that summarization of the video is performed after the video recording is finished.

In an implementation, a video data processing system for providing real time summarization of the video during the video recording is provided. In this implementation, during the video recording, device signals and user-specified region-of-interest are inputted into the importance analyzer for analysis, and may then be used to summarize the large video based on the analysis result on the fly by the video encoder.

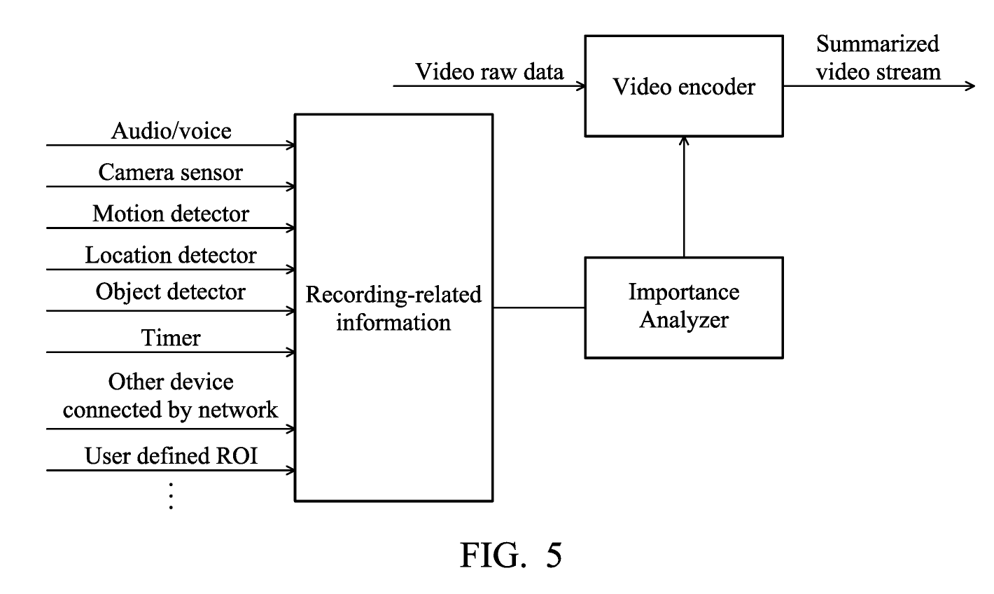

FIG. 5 is a diagram of a video data processing system in accordance with another implementation of the disclosure. In this implementation, the video data processing system at least comprises a plurality of sources, an importance analyzer and a video encoder. The sources, importance analyzer and video encoder of the video data processing system as shown in FIG. 5 may be implemented by the sensors or detectors 180, the importance analyzer 190 and the video encoder 170 of the video data processing system 10 in FIG. 1A, respectively, for example.

As shown in FIG. 5, the sources are configured to generate a plurality of recording-related information during recording video data. The sources can be one or more of following: audio-based signal detectors, camera sensors, motion detectors, location detectors, object detectors, timers, devices from a connected network or ROI detectors, but the disclosure is not limited thereto. The recording-related information may comprise information regarding one or more of the following: audio-based signal detection, camera sensor information, motion detector information, location detector information, object detector information, timer information, other device information from a connected network or user defined ROI information.

The importance analyzer is configured to receive the recording-related information from the sources and extract required information from the recording-related information to generate metadata information for the recorded video data. The video encoder is coupled to the importance analyzer and is configured to receive video raw data of a recorded video from a video source (e.g., the video capture device 160) and the metadata information and crop the received video data to generate cropped video data based on the metadata information and generate the summarized video of the recorded video data based on the cropped video data.

In another implementation, a video data processing system for providing non-real time summarization of the video is provided. In this implementation, during the video recording, device signals, user-specified ROI and other recording-related information are inputted into the importance analyzer for analysis and the result (so-called metadata information) is saved in encoded bitstream and a large video can be summarized based on the metadata information in off line.

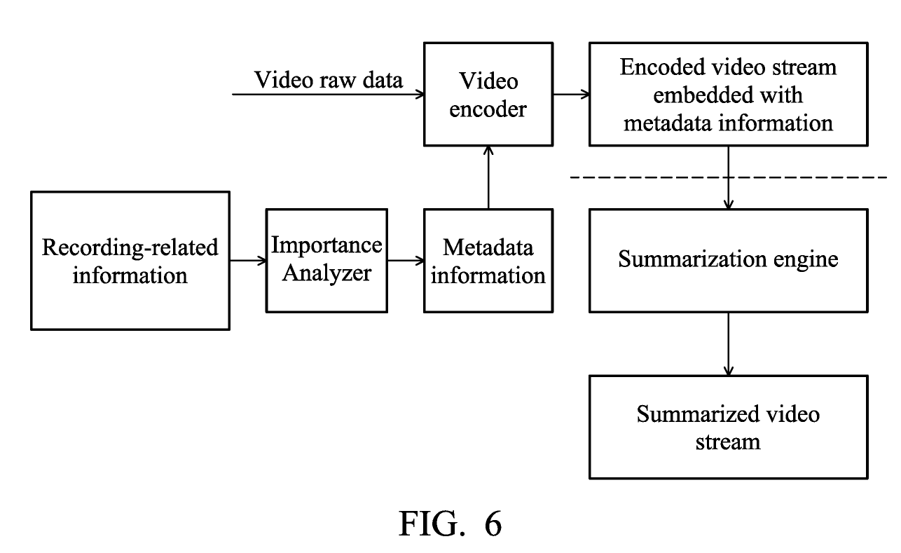

FIG. 6 is a diagram of a video data processing system in accordance with another implementation of the disclosure. In this implementation, the video data processing system at least comprises a plurality of sources, an importance analyzer, a video encoder and a summarization engine. The sources, importance analyzer, video encoder and summarization engine of the video data processing system as shown in FIG. 6 may be implemented by the sensors or detectors 180, the importance analyzer 190, the video encoder 170 and the summarization engine 200 of the video data processing system 10 in FIG. 1A or FIG. 1B, respectively, for example. The importance analyzer obtains required information from all of the resources and generates metadata information. The video encoder is coupled to the importance analyzer and is configured to receive video raw data from a video source (such as the video capture device 160) and the metadata information and encode the recorded video data to generate an encoded video bitstream with the metadata information. The encoded video bitstream with the metadata information can be stored in a storage device (such as, the memory unit 140 or other external storage device), for example. After the video recording is finished, in off-line, the summarization engine, either in internal or in external, retrieves encoded video bitstream embedded with the metadata information from the storage device and generates a summarized video stream according to the encoded video stream and the metadata information included in the encoded video bitstream.

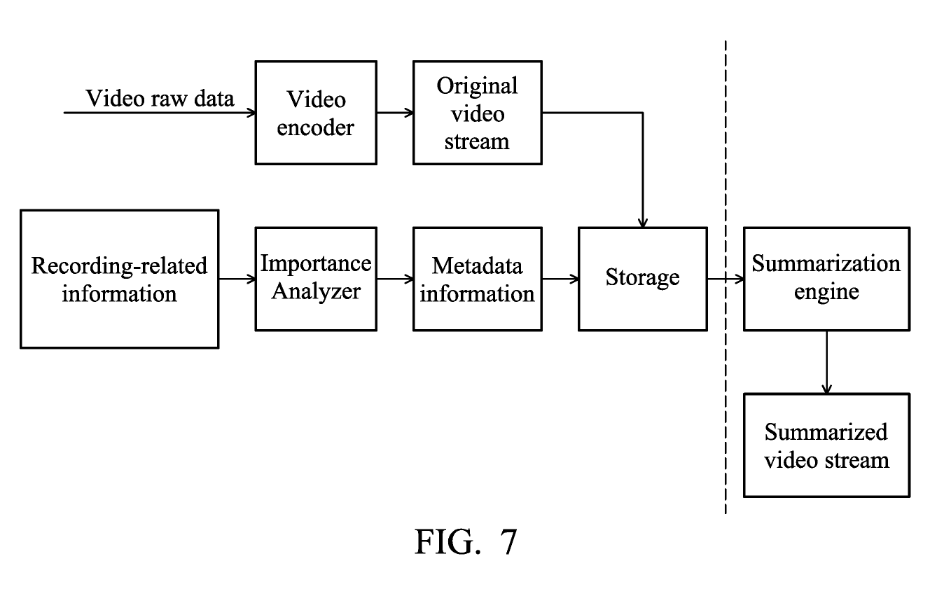

In yet another implementation, another video data processing system for providing non-real time summarization of the video is provided. FIG. 7 is a diagram of a video data processing system in accordance with another implementation of the disclosure. In this implementation, the video data processing system at least comprises a plurality of sources, an importance analyzer, a video encoder and a summarization engine. The sources, importance analyzer, video encoder and summarization engine of the video data processing system as shown in FIG. 7 may be implemented by the sensors or detectors 180, the importance analyzer 190, the video encoder 170 and the summarization engine 200 of the video data processing system 10 in FIG. 1A, FIG. 1B or FIG. 1C, respectively, for example. During recording video data, the importance analyzer obtains recording-related information from all of the resources and generates metadata information. The video encoder receives video raw data from a video source (such as the video capture device 160) and encodes the video raw data to generate an encoded original video bitstream. The encoded original video bitstream and the metadata information can then be stored in a storage device (such as, the memory unit 140 or other external storage device), for example. After the video recording is finished, in off-line, the summarization engine, either in internal or in external, retrieves the encoded original video bitstream and the metadata information from the storage device and generates a summarized video stream according to the encoded video stream and the metadata information.

In view of the above implementations, a video data processing system and an associated method for generating a summarized video of a recorded video are provided. The importance analyzer of the video data processing system may retrieve respective metadata information and determine important or required segments automatically from the recorded frames based on the metadata information and automatically remove undesirable portions of the video without needing the user manual editing, thus achieving better efficiency for video recording. For example, when a specific device signal is detected, the original video raw data can be cropped to a summarized video with a smaller resolution or a smaller video length. Accordingly, the required storage of the frame buffer can be significantly reduced, and thus the required memory bandwidth can be reduced and encoding complexity can also be saved. Moreover, summarization of the video can be performed on the fly on the encoder side or be performed off line on the transcoder side, thereby providing more flexibility in video summarization.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms. For example, implementation can be accomplished via a hardware apparatus or a hardware and software apparatus. An apparatus may be implemented in, for example, appropriate hardware, software, and firmware. The methods may be implemented in an apparatus such as, for example, a processor, which refers to any processing device, including, for example, a computer, a microprocessor, an integrated circuit, or a programmable logic device.

While the disclosure has been described by way of example and in terms of the preferred embodiments, it is to be understood that the disclosure is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for generating a summarized video of a recorded video in a video data processing system, comprising:
receiving video data and recording-related information that is generated during video recording from at least one source;
analyzing the recording-related information and extracting required information from the recording-related information to generate metadata information for the received video data;
cropping the received video data to generate cropped video data based on the metadata information; and
generating a summarized video of the recorded video data based on the cropped video data.

2. The method as claimed in claim 1, wherein the data size of the cropped video data is smaller than that of the received video data.

3. The method as claimed in claim 1, wherein an image quality of the cropped video data is the same as that of the received video data.

4. The method as claimed in claim 1, wherein the step of cropping the received video data to generate cropped video data based on the metadata information comprises:
determining at least one importance portion of the received video data based on the metadata information; and
cropping the received video data to include the at least one importance portion in the generate cropped video data.

5. The method as claimed in claim 4, further comprising:
performing an region-of-interest (ROI) detection on video frames of the received video data based on a predetermined ROI data to detect at least one ROI position on the received video data;
marking the video frames with the ROI detected as the importance portions of the received video data; and
generating the cropped video data according to the marked video frames.

6. The method as claimed in claim 5, further comprising:
determining whether a size of the detected ROI matches a desired resolution; and
resizing a cropping region of the detected ROI based on a size of a previously cropped ROI when the size of the detected ROI does not match the desired resolution,
wherein the cropping region of the detected ROI is expanded to the desired resolution based on the size of the previously cropped region if the size of the detected ROI is smaller than the desired resolution, or the size of the cropping region of the detected ROI is cropped to the desired resolution based on the size of the previously cropped region if the size of the detected ROI is larger than the desired resolution.

7. The method as claimed in claim 5, wherein the step of performing the ROI detection further comprises:
finding a plurality of ROIs on a specific video frame of the received video data; and
selecting one of the ROIs to be the detected ROI of the specific video frame based on a position of a previously cropped ROI.

8. The method as claimed in claim 5, wherein the step of performing the ROI detection further comprises:
finding a plurality of ROIs on a specific video frame of the received video data; and
dividing the ROIs into a picture-in-picture (PIP) form on the specific video frame.

9. The method as claimed in claim 1, wherein the step of cropping the received video data to generate cropped video data based on the metadata information comprises:
determining at least one removing portion of the received video data based on the metadata information; and
cropping the received video data to exclude the at least one removing portion in the generate cropped video data.

10. The method as claimed in claim 1, wherein the step of generating the summarized video of the recorded video data based on the cropped video data further comprises:
remapping or warping the cropped video data to remove distortion on the cropped video data; and
encoding the remapped or warped video data to generate the summarized video of the recorded video data.

11. The method as claimed in claim 1, wherein the sources comprises one or more of following: audio-based signal detector, camera sensor, motion detector, location detector, object detector, timer, a device from a connected network or a ROI detector.

12. The method as claimed in claim 1, wherein the required information is selected from one or more of following information: audio-based signal detection information, camera sensor information, motion detector information, location detector information, object detector information, timer information, information from the device of the connected network or user defined ROI information.

13. A video data processing system, comprising:
an importance analyzer, configured to receive recording-related information from at least one source and extract required information from the recording-related information to generate metadata information for the recorded video data; and
a video encoder, coupled to the importance analyzer and configured to receive the recorded video data and the metadata information and crop the received video data to generate cropped video data based on the metadata information and generate the summarized video of the recorded video data based on the cropped video data.

14. A video data processing system, comprising:
an importance analyzer, configured to receive recording-related information generated during recording video data from at least one source and extract required information from the recording-related information to generate metadata information for the recorded video data;
a video encoder, coupled to the importance analyzer and configured to receive the recorded video data and the metadata information and encode the recorded video data to generate an encoded video bitstream embedded with the metadata information; and
a summarization engine, configured to receive the encoded video bitstream with the metadata information and crop the encoded video bitstream to generate cropped video data based on the metadata information and generate the summarized video of the recorded video data based on the cropped video data.

15. A video data processing system, comprising:
an importance analyzer, configured to receive recording-related information generated during recording video data from at least one source, extract required information from the recording-related information to generate metadata information for the recorded video data and store the metadata information into a storage device;
a video encoder, configured to receive the recorded video data and encode the recorded video data to generate an encoded video bitstream; and
a summarization engine, configured to receive the encoded video bitstream and obtain the metadata information from the storage device, crop the encoded video bitstream to generate cropped video data based on the metadata information and generate the summarized video of the recorded video data based on the cropped video data.
